(19) United States
(12) Patent Application Publication
(10) Pub. No.: US 2007/0273223 A1
(43) Pub. Date: Nov. 29, 2007

(54) Power capacitors mounted diametrically on electric motors

(76) Inventors: Terence G. Ward, Redondo Beach, CA (US); Alex Thompson, Fullerton, CA (US); Brian Welchko, Torrance, CA (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/440,848

(22) Filed: May 25, 2006

(51) Int. Cl. H02K 11/00

(52) U.S. Cl. 310/72; 310/68 R; 310/89

(57) ABSTRACT

Alternating current motors used to drive wheels of hybrid or fuel cell vehicles have capacitors which are mounted diametrically on the motors, i.e., mounted around the diameter of the motors. The capacitors may be annular or arcuate in shape. By so configuring the power capacitors, axial space adjacent to the motors is reduced, providing enhanced design flexibility for automotive vehicles.

### FIELD OF THE INVENTION

The present invention is directed to power capacitors mounted diametrically on electric motors. More particularly, the present invention relates to power capacitors mounted diametrically on AC motors used as traction motors for automotive vehicles.

### BACKGROUND OF THE INVENTION

In configuring automotive vehicles, efficient use of space is an important consideration. This is because various components of automotive vehicles frequently compete for space within the envelope defined by vehicle bodies. The judicious use of space is a consideration not only during assembly of automotive vehicles, but also during maintenance of vehicles. In addition, consuming less space for essential automotive components allows the designer to increase space for optional components and for cabin capacity. While adjusting or decreasing space consumption of one component may not appear to have substantial design effects, cumulative space adjustments and decreased space consumption for several components can result in more efficient use of space within a vehicle and enhanced design flexibility.

In voltage source inverter arrangements, capacitors are used as voltage storage devices providing power buffers to maintain relatively smooth dc link voltages. Typically, capacitance volume accounts for a significant portion of the total volume required by voltage source inverter packaging. Such capacitors are frequently electrolytic or film capacitors. These capacitors are manufactured by winding a thin film to increase the total amount surface area of the film. In the prior art, such capacitors are usually wound tightly around their center to produce an enclosed or solid cylinder of different heights and diameters.

In order to reduce loses and EMI, which results from the transmission of power between an electric drive (inverters and capacitors) and an electric motor, it is often desirable to minimize transmission distance between electric drives and motors. In order to minimize distance, the electric drive can be integrated into a common package with a motor. Thus, the electric drive in current design may be in the form of a container having both inverter and capacitance circuitry attached to the outside of a motor. The electric drive is thus integrated with the motor by attaching the electric drive configured as a cylinder, to the end of the motor. By attaching the drive to the end of the motor, the axial length is necessarily increased. In many packaging applications, axial space is limited, and by attaching the electric drive to the end of the motor, the electric motor may need to be reduced in axial length, which results in a loss of power and torque output capacity. Since capacitance required by electric drives consumes significant volume, relocating the capacitance decreases the volume of remaining electric drive components, thus decreasing the axial length of electric drive packages on the end of the motor. Since axial length is often a more restrictive dimension of an electrical drive system than width, reducing axial length can have desirable results.

### SUMMARY OF THE INVENTION

An alternating current electric motor assembly comprises an alternating current electric motor having a rotor and a drive shaft for rotation around an axis in combination with a stator positioned around the rotor and a power capacitor diametrically mounted with respect to the stator and electrically connected to windings of the motor.

In another aspect of the assembly, a housing surrounds the outer periphery of the stator and the power capacitor is positioned diametrically on the housing.

In another aspect of the assembly, the power capacitor is annular.

In still another aspect of the assembly, the power capacitor is arcuate.

In still another aspect of the assembly, the motor is a tractor motor for an automotive vehicle.

In still a further aspect of the assembly, an inverter is axially mounted on the motor with the power capacitor being diametrically mounted on the motor.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a schematic view of a hybrid automotive vehicle utilizing an electric motor with a diametrically mounted capacitor;

FIG. 2 is a schematic illustration of a fuel cell powered vehicle having an electric motor with a diametrically mounted capacitor.

FIG. 3 is a side view of an electric motor with a diametrically mounted annular capacitor in accordance with a first embodiment of the invention;

FIG. 4 is a view taken along line 4-4 of FIG. 3;

FIG. 5 is a side, bottom or top view of an electric motor with a diametrically mounted arcuate capacitor in accordance with the second embodiment of the present invention;

FIG. 6 is an elevation taken along lines 6-6 of FIG. 5;

FIG. 7 is a top, side view or bottom view of a motor having a capacitor of increased axial length mounted diametrically thereon according to a third embodiment of the invention, and

FIG. 8 is an elevation taken along lines 8-8 of FIG. 7.

### DETAILED DESCRIPTION

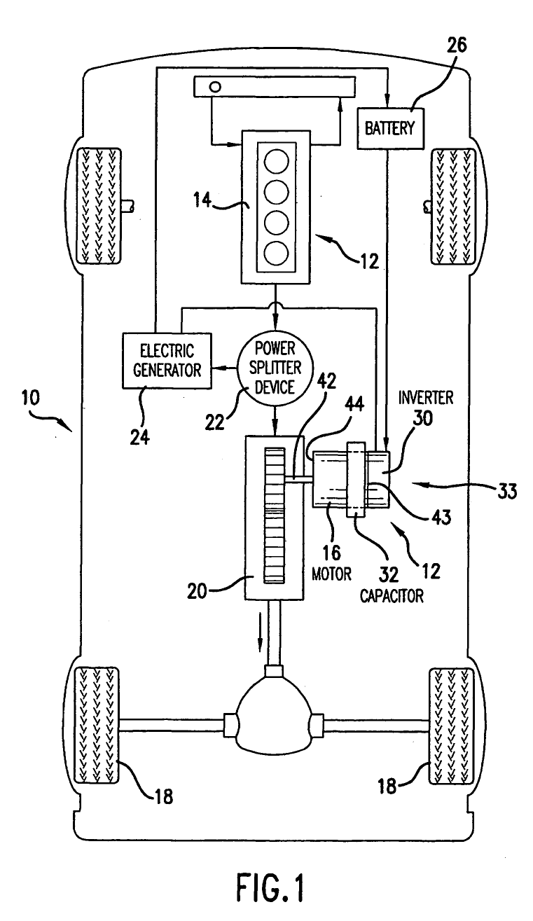

Referring now to FIG. 1 there is schematically shown a vehicle 10 with a hybrid drive 12 comprising an internal combustion engine 14 and an alternating current (AC) motor 16. The internal combustion engine 14 and AC motor 16 drive wheels 18 through a transmission 20. A power splitter device 22 drives an electric generator 24 to charge a battery 26 (which may be configured as a bank of batteries) when the internal combustion engine 14 is running. The electric generator 24 can under selected circumstances power the electric motor 16 to run simultaneously with the internal combustion engine 14. The battery 26 and the electric generator 24 deliver DC current to an inverter 30 which is illustrated as axially mounted and integral with the AC motor 16. Also integral with the AC motor 16 is a power capacitor 32. In accordance with the present invention, the power capacitor 32 is diametrically mounted on the motor 16 to form a motor assembly 33 comprised of the motor 16, the inverter 30 and the capacitor 32. The term diametrically mounted means mounted around the diameter of the motor 16.

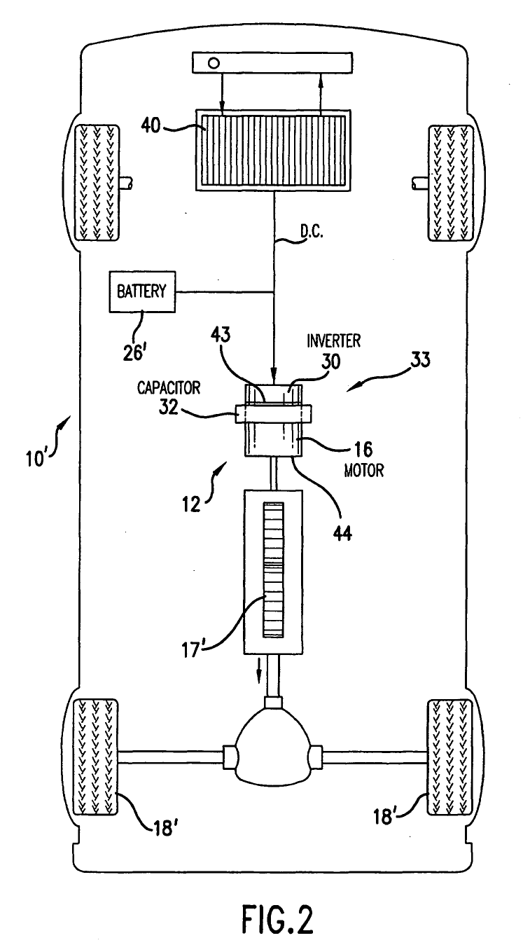

Referring now to FIG. 2, FIG. 2 is similar to FIG. 1 with the exception that the vehicle 10′ is powered by a fuel cell 40 that both charges a battery 26 and provides direct current to the inverter 30 of the AC motor assembly 33. The AC motor assembly 33 is configured similarly to the AC motor assembly 33 of FIG. 1, wherein an axial mounted inverter 30 turns direct current from the fuel cell 40 into AC and wherein the power capacitor 32 is mounted diametrically on the AC motor 16.

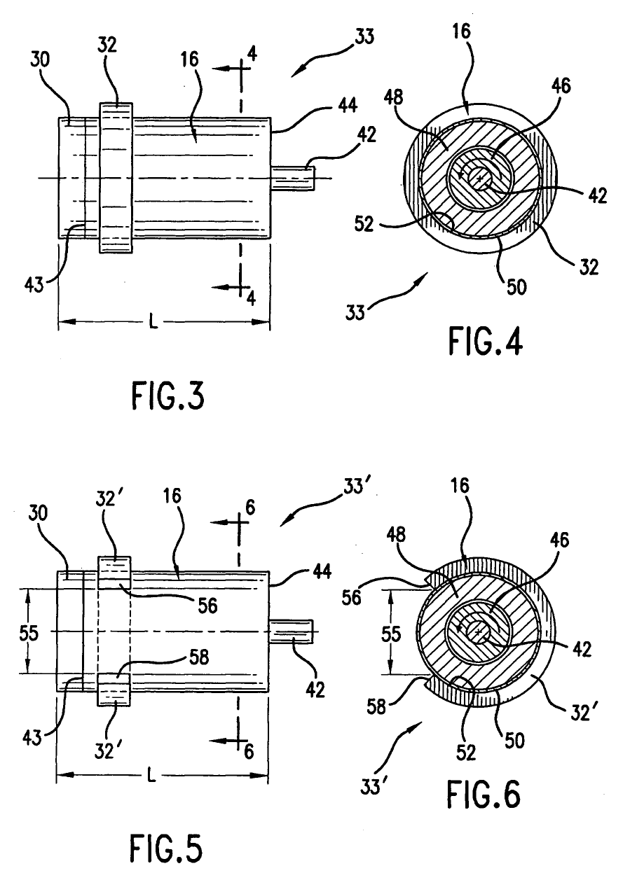

Referring now to FIGS. 3 and 4, there is shown a first embodiment of the invention wherein the motor assembly 33 shown in FIGS. 1 and 2 has the inverter 30 mounted on a first end 43 of the AC motor 16 to extend axially with the motor, while the power capacitor 32 is mounted diametrically on the AC motor and connected to the windings of the AC motor. As is seen in FIG. 4, the motor 16 has an output shaft 42 which projects from a second end 44 of the AC motor. The output shaft 42 is fixed with respect to an armature 46 of the AC motor, which armature rotates inside of a stator 48. The stator 48 is surrounded by a housing 50 on which the power capacitor 32 is mounted diametrically. In FIGS. 3 and 4, the power capacitor 32 is annular having a circular interior surface 52 in which the motor 16 is received. Preferably, the power capacitor 32 is mounted on the exterior surface of the housing 50, but it may be configured so as to be positioned within the housing 50.

By mounting the power capacitor 32 diametrically on the AC motor 16, the axial length L of the motor assembly 33 is limited to the length of the AC motor plus the inverter 30. Thus, the motor assembly 33 consumes less axial space. Since axial space is a more restrictive design dimension, the reduction in axial extent of the motor assembly 33 frees considerable axial space while consuming minimal additional radial space.

Referring now to FIGS. 5 and 6, the motor assembly 33′ of a second embodiment has substantially the same structure as the assembly 33 of FIGS. 1-4, with the same reference numerals identifying similar structure. In FIGS. 5 and 6, the capacitor 32′ is arcuate rather than annular, with a gap 55 between the ends 56 and 58 of the capacitor 32′. The arc of the capacitor may be 270° instead of 360° or may be another arcuate length.

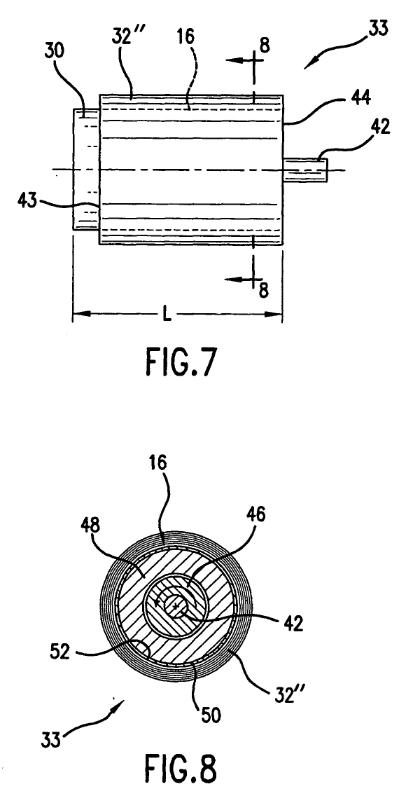

Referring now to FIGS. 7 and 8, where a third embodiment of the motor assembly 33″ is shown, it is seen that the capacitor 32″ is axially elongated as compared to the capacitors 32 and 32′ of FIGS. 1-6. The axial extent of the capacitor 32″ is substantially the same as the defined axial length of the motor 16 as shown in FIG. 7, however the axial extent can be even longer than the axial length of the motor in either direction. For example, the length of the capacitor 32′ may extend over the inverter 30 or over the output shaft 42. Moreover, the axial length of the capacitor 32′ may be greater than that illustrated in FIGS. 3 and 4, but not as long as the axial length of the motor 16. In addition, in the embodiment shown in FIGS. 7 and 8, the capacitor 32″ may be arcuate like the capacitor 32′, rather than annular like the capacitor 32 shown in FIGS. 3 and 4.

By mounting the capacitors 32, 32′ and 32″ on the motor housing 50 as shown in FIGS. 1-8, it is possible to increase the amount of capacitance employed as a result of the large surface area available. As a result, the reliability of the motor assemblies 33, 33′ and 33″ of the present invention can be increased. In addition, because the voltage on the capacitors 32, 32′ and 32″ is substantially DC, the capacitors themselves may serve to shield the motor 16 against undesirable electromagnetic interference from other components of the vehicle 10 or from electromagnetic interference exterior to the vehicle.

Design configurations may locate the inverter 30 remote from the electric motor 16, however the benefits of diametric mounting locations for the capacitors 32, 32′ and 32″ still provide advantages of reduced axial length and electromagnetic shielding for drive packages comprising motors with just capacitors in integral assembly with the motor 16.

An additional design tradeoff, made available by utilizing the diametrically mounted capacitors 32, 32′ and 32″, is an increase in available space for increased axial length of the motors 16, resulting in increased output power and torque.

Annular and arcuate capacitor configurations are available from SBE, Inc., SB Electronics Division located in Barre, Vt.

From the foregoing description, one skilled in the art can easily ascertain the essential characteristics of this invention, and without departing form the spirit and scope thereof, can make various changes and modifications of the invention to adapt it to various usages and conditions.

We claim:

1. An AC motor assembly comprising:
an alternating current electric motor having a rotor and a drive shaft for rotation around an axis,
a stator positioned around the rotor and having an inner periphery and an outer periphery, and
a power capacitor disposed around the electric motor and electrically connected to windings of the motor.

2. The assembly of claim 1 wherein a housing surrounds the outer periphery of the stator and the power capacitor is disposed around the housing.

3. The assembly of claim 2 wherein the power capacitor is annular.

4. The assembly of claim 2 wherein the power capacitor is arcuate.

5. The assembly of claim 4 wherein the power capacitor has an arcuate length of about 270°.

6. The assembly of claim 2 wherein the motor has a defined axial length and the power capacitor has an axial length at least substantially as long as the length of the motor.

7. An AC motor assembly comprising:
an AC tractor motor for an automotive vehicle, the tractor motor having a rotor with a drive shaft coupled to at least one wheel of the vehicle to drive the vehicle;
a stator positioned around the rotor, the stator having an inner periphery and an outer periphery, and
a power capacitor disposed around the outer periphery of the stator and electrically connected to the windings of the motor.

8. The assembly of claim 7 wherein a housing surrounds the outer periphery of the stator and the power capacitor is positioned diametrically on the housing.

9. The assembly of claim 8 wherein the power capacitor is annular defining a hollow central core in which the AC motor is positioned.

10. The assembly of claim 8 wherein power capacitor is arcuate terminating with two ends separate by a gap.

11. The assembly of claim 10 wherein the power capacitor has an arcuate length of about 270°.

12. The assembly of claim 87 wherein the motor has a defined axial length and the power capacitor has an axial length at least substantially as long as that of the motor.
